(19) United States
(12) Patent Application Publication
(10) Pub. No.: US 2007/0080235 A1
(43) Pub. Date: Apr. 12, 2007

(54) Temperature controller backup device

(75) Inventor: George H. Fulton JR., Vineland, NJ (US)

Correspondence Address: JOHN F. LETCHFORD, ARCHER & GREINER, P.C., ONE CENENNIAL SQUARE, HADDONFIELD, NJ, 08033, US

(73) Assignee: Ace Glass Incorporated

(21) Appl. No.: 11/354,756

(22) Filed: Feb. 15, 2006

Related U.S. Application Data
(60) Provisional application No. 60/724,382, filed on Oct. 7, 2005.

(51) Int. Cl. F23D 5/14; G05D 23/12

(52) U.S. Cl. 236/1 A; 236/1 C

(57) ABSTRACT

A temperature controller device including informative display screens, predeterminable heating cycles, automated system checks and other utilities that reduces human involvement in a monitoring process. The device may be incorporated into a temperature controller or may be a separate “stand alone” unit.

### CROSS REFERENCE TO RELATED APPLICATION

The present application claims the benefit of U.S. Provisional Patent Application No. 60/724,382 filed Oct. 7, 2005, which is incorporated herein by reference in its entirety.

### FIELD OF THE INVENTION

The present invention relates in general to temperature controllers and in particular to a backup device therefor.

### BACKGROUND OF THE INVENTION

Temperature controllers are widely used to control the operation of heating and cooling apparatus used in products and processes where temperature plays an important role. They are routinely used to control heaters and coolers in laboratory and industrial environments where temperature conditions must be tightly controlled. Typically, a temperature controller for use in such environments includes at least one sensor probe and circuitry in communication with the probe which is operable to automatically cut power to a heater or cooler in the event the probe detects a temperature that exceeds a predetermined maximum acceptable temperature or falls below a predetermined minimum acceptable temperature for a particular process under consideration. When the power is cut to the heater, the temperature controller may or may not be manually reset before the monitored process may proceed. Likewise, the temperature controller may or may not be manually reset if a power outage occurs.

For example, presently available laboratory and industrial controllers for heaters display the target temperature of the process being monitored and the maximum or minimum temperatures permissible for the process (i.e., shut-off temperature). A technician observing the equipment should personally monitor the status of the process and react quickly to manually reset and restart the controller in the event of a power outage. In addition, the technician must physically turn off the controller when the monitored process is believed to be complete. That is, conventional temperature controllers are deployed for an indefinite period of time in either an “on” state or an “off” state, both of which must be manually selected by the technician, which requires the technician to pay close attention to time.

An advantage exists, therefore, for a fully automated temperature controller device that requires minimal user attention and involvement in the monitoring process.

### SUMMARY OF THE INVENTION

The present invention provides a backup temperature controller device incorporating several features, modalities and functions heretofore unavailable in presently existing backup temperature controllers. More particularly, the device includes informative display screens, predeterminable finite heating or cooling sequences, automated system checks and other utilities not present in conventional temperature controllers. The result is a device that greatly reduces human involvement in the monitoring process. It may be incorporated into a heating or cooling apparatus temperature controller or may be a separate “stand alone” unit.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments thereof shown, by way of example only, in the accompanying drawings wherein:

FIG. 1 is a block diagram of the system architecture of a heating or cooling apparatus temperature controller backup device according to the present invention;

FIG. 2 is a schematic diagram of testing procedure employing a primary temperature controller backed up by a temperature controller backup device according to the present invention as a separate stand-alone device;

FIG. 3 is a block diagram of a display sequence demonstrating the manner by which user-adjustable operational parameters of a temperature controller backup device according to the present invention are set when a mode switch of the device is in an “adjust” position;

FIG. 4 is a block diagram of a display sequence of a temperature controller backup device according to the present invention when a mode switch of the device is in an “reset” position; and

FIGS. 5A and 5B are block diagrams of the operational flow and system displays of a temperature controller backup device according to the present invention occurring during a “run” sequence when the device is set according to the operational parameters input by a user pursuant to FIG. 3.

### DETAILED DESCRIPTION OF THE INVENTION

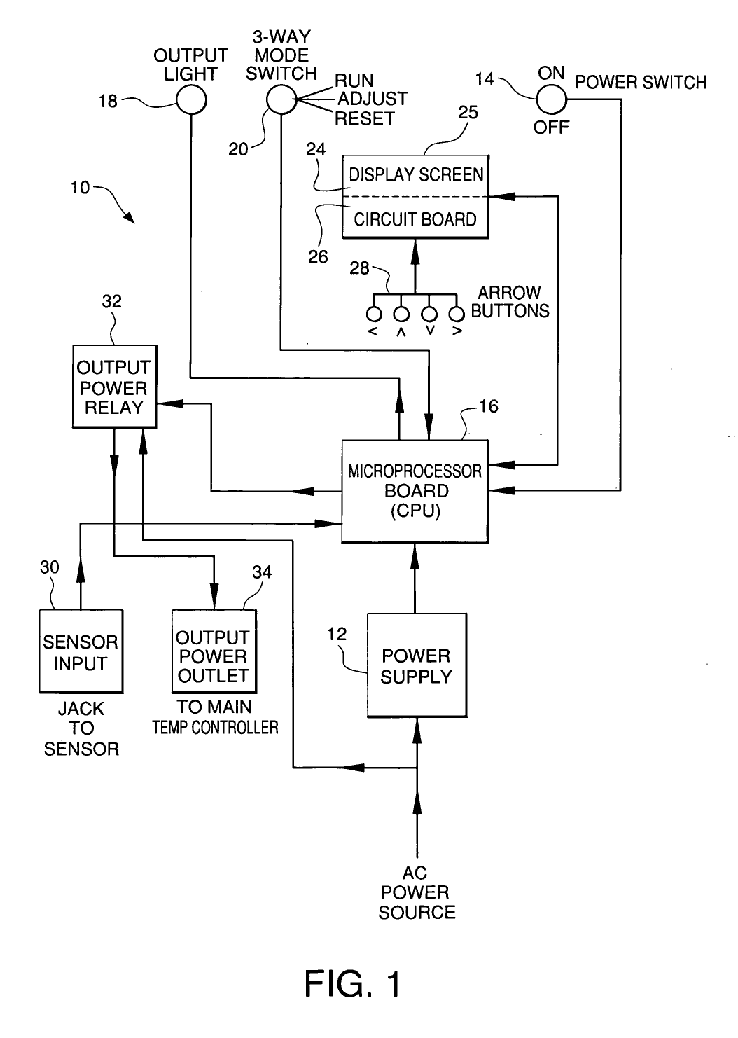

Referring to the drawings wherein like or similar references indicate like or similar elements throughout the several views, there is shown in FIG. 1 the system architecture of a temperature controller backup device according to the present invention. The instant device, identified generally by reference numeral 10, includes a power supply 12 which receives power from a suitable AC power source such as, for example, a 120V 50/60 Hz 15A source (although different voltages and currents are contemplated to be within the scope of the invention depending on the electrical requirements of the country in which testing is performed) and converts the incoming power to 5V DC. Under control of a power switch 14, power supply 12 delivers power to a main microprocessor board or central processing unit (CPU) 16. When the power switch is in the “on” position, the main microprocessor board delivers power via an output power relay, discussed below, to an output light 18 such as an LED or other suitable light source to indicate that the output device is powered up.

With power switch 14 “on” the operation of device 10 is dictated by the position of a 3-way mode switch 20 that establishes three modes of operation: run, adjust and reset, which are described in greater detail hereinafter. Depending on the position of switch 20, the main microprocessor board 16 may extract and process information from suitable memory means, for instance, a constantly-powered, erasable and reprogrammable nonvolatile memory such as flash memory preferably carried by the microprocessor board. Likewise, the selected position of switch 20 prescribes what information a user observes on a display screen 24 of a display means 25.

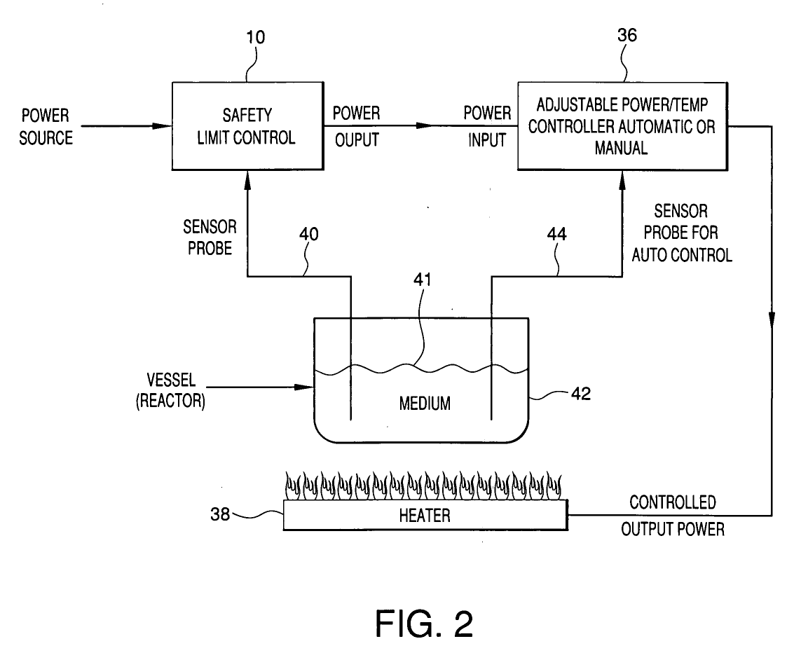

A sensor input 30 includes connection means such as a jack for connection to a suitable thermocouple or other temperature sensing device (not illustrated). Sensor input 30 transmits sensed temperature data to microprocessor board 16, which information in turn is displayed on the display screen 24 during a “run” sequence, described below. In addition to power supply 12, AC power is delivered directly to an output power relay 32 for controlled delivery by the relay to a main temperature controller. More particularly, depending on the sensed temperature data of the medium or process under scrutiny, or under certain conditions during heater testing (described below), microprocessor board 16 commands output power relay 32 to supply or terminate AC power flow to an output power outlet means 34 in communication with a primary or main temperature controller 36 (FIG. 2). Power outlet means 34 may be a dedicated output jack or similar device.

For brevity, the present invention is described and illustrated as it would be used in connection with control of a heating device. However, it will be understood that device 10 may be employed to control coolers, refrigerators, freezers and similar cooling apparatus in addition to heating apparatus. Additionally, FIG. 2 depicts device 10 is shown as a separate stand-alone unit from the main temperature controller. It will be further understood that temperature controller backup device 10 may incorporated into the same housing as the main temperature controller 36. And, if incorporated into the same housing, it will be understood that power outlet means 34 may be an output jack or a direct jack-free connection between the output power relay and the main temperature controller.

The arrangement shown in FIG. 2 is representative, although not limitative, depiction of but one possible implementation of device 10. That is, FIG. 2 shows how device 10 might be connected to a main temperature controller in a laboratory environment. As is known, main temperature controller 36 may be an automatically or manually adjustable power/temperature controller whose output controls a heater 38. A first sensor probe 40 connected to device 10 is immersed in a fluid (liquid or gas) testing medium 41 contained in a vessel or reactor 42. A second sensor probe 44 connected to main temperature controller 36 is likewise immersed in the medium. Device 10 and controller 36 are arranged in series whereby controller derives its power input directly from the output power of device 10 which in turn is connected to an AC power source.

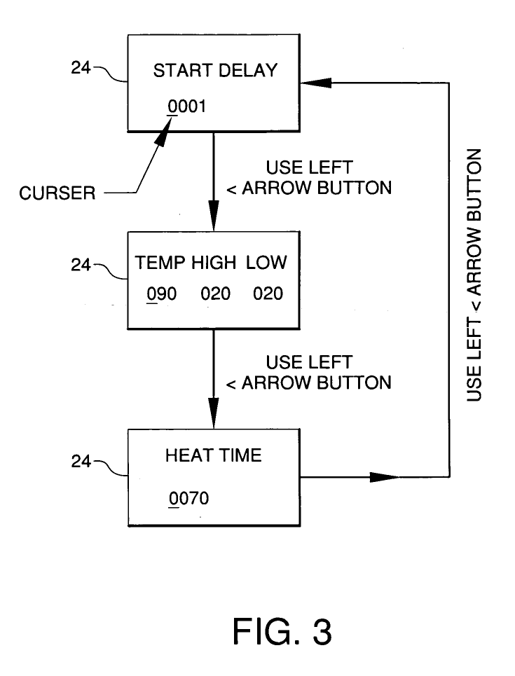

Depending on the position of the 3-way mode switch 20 and in response to prompts shown on the display screen 24, a user may interact with a circuit board 26 of display means 25 via arrow keys or similar input means 28. Circuit board 26 in turn communicates the user input to microprocessor board 16. FIG. 3 reveals a series of display screens 24 a user encounters when the 3-way mode switch 20 is placed in the “adjust” position. In “adjust” a user may program device 10 with desired time and temperature parameters. In the first screen the user is asked to enter a desired “Start Delay” time. With this capability the user may use arrow keys 28 to select the time in minutes he or she wishes to delay the start of device 10. The right arrow moves the curser to the right, the left arrow moves the cursor to the left, the up arrow increases the numerical digit and the down arrow decreases the numerical digit. The delay start time may range from 1 to 9998 minutes. If 9999 is selected, device 10 remains off. When the desired “Start Delay” time is input, the user then presses the left arrow button to proceed to the next programming display screen.

At the next screen, the user inputs the desired target process temperature, as well as “high” and “low” temperature limits which together define the maximum and minimum process temperatures of an acceptable temperature band for the monitored process. In the illustrated example, the target process temperature is 90° C. and the “high” and “low” temperature limits are each 20° C. whereby the acceptable temperature range for the process is 70° C.-110° C. It will be understood that the foregoing may also be expressed in ° F., if desired. When the target process temperature and temperature band information has been programmed, the user then presses the left arrow button to proceed to the final “adjust” screen. At this screen, the user selects either a finite or infinite heat sequence time. In the illustrated example, a 70 minute heat sequence is chosen. The heat sequence time may range from 1 to 9998 minutes. If 9999 is selected, device 10 remains on indefinitely during the heat sequence until the user either readjusts the heat sequence time to a finite time or manually switches the device off using power switch 14. If the user wishes to change any of the input data, he or she simply depresses the left arrow button to select the desired display screen and makes any necessary changes. If the 3-way mode switch 20 is switched from the “reset” position to the “adjust” position output power to the main temperature controller remains off. If the 3-way mode switch 20 is switch from the “run” position to the “adjust” position output power to the main temperature controller is governed by the run sequence until reprogrammed by the user. According to the present invention, a user preferably can switch to “adjust” mode to change the five selectable input values while in the “run” mode, described below, without interrupting the run. The user may then switch back to “run” mode to continue monitoring so long as the “high” and “low” temperature band or timing limits were not exceeded because of the reprogramming.

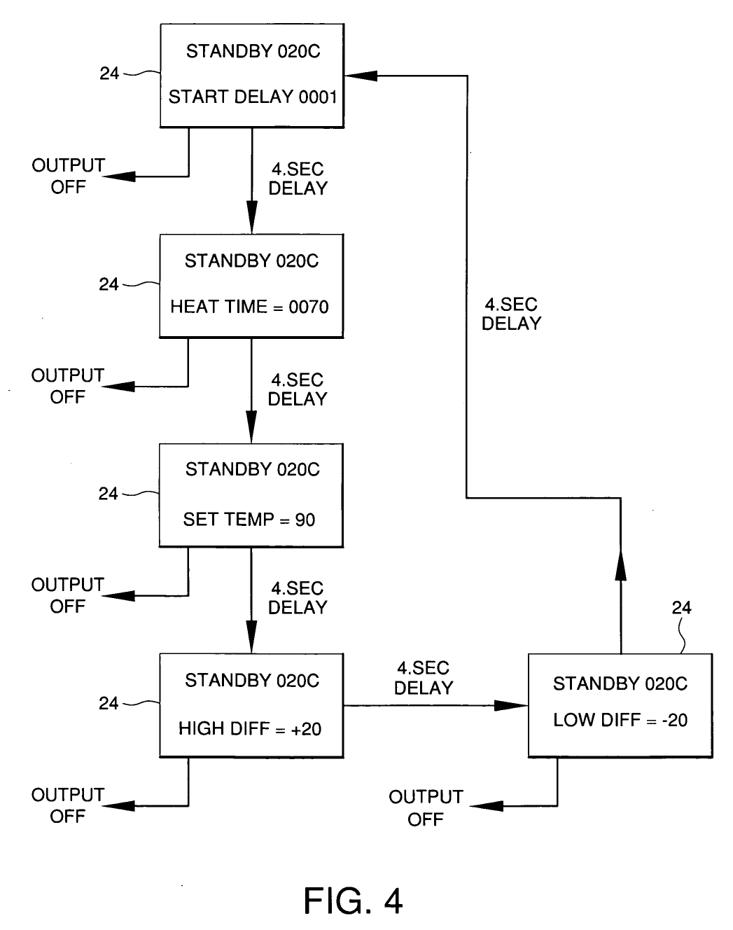

FIG. 4 reveals a series of display screens 24 a user encounters when the 3-way mode switch 20 is placed in the “reset” position. Common to each of the screens is the present process “standby” temperature which, prior to a process run, is normally about ambient room temperature (e.g., typically about 20° C.). The first “reset” screen shows the programmed start delay time for 4 seconds. Following elapse of the 4 second delay, a second screen appears which displays the selected heat time for 4 seconds. Thereafter, a process temperature screen appears for 4 seconds which displays the selected temperature for the process, followed thereafter by screens displaying the high and low temperature band limit temperatures, again each for 4 seconds. After display of the low limit temperature, the reset system automatically cycles back to the standby temperature screen. It will be understood that the screen delay time of 4 seconds is merely exemplary. The screen delay time is stored in the aforementioned memory means and can be set to any time suitable for the user or the process under consideration.

At all times throughout the reset mode output power to the main temperature controller and any run sequences are shut off. If in reviewing the reset mode screens the operator identifies certain parameters that should be changed, the 3-way mode switch 20 is switched to the “adjust” position and appropriate changes may be made to those parameters as described above in connection with FIG. 3.

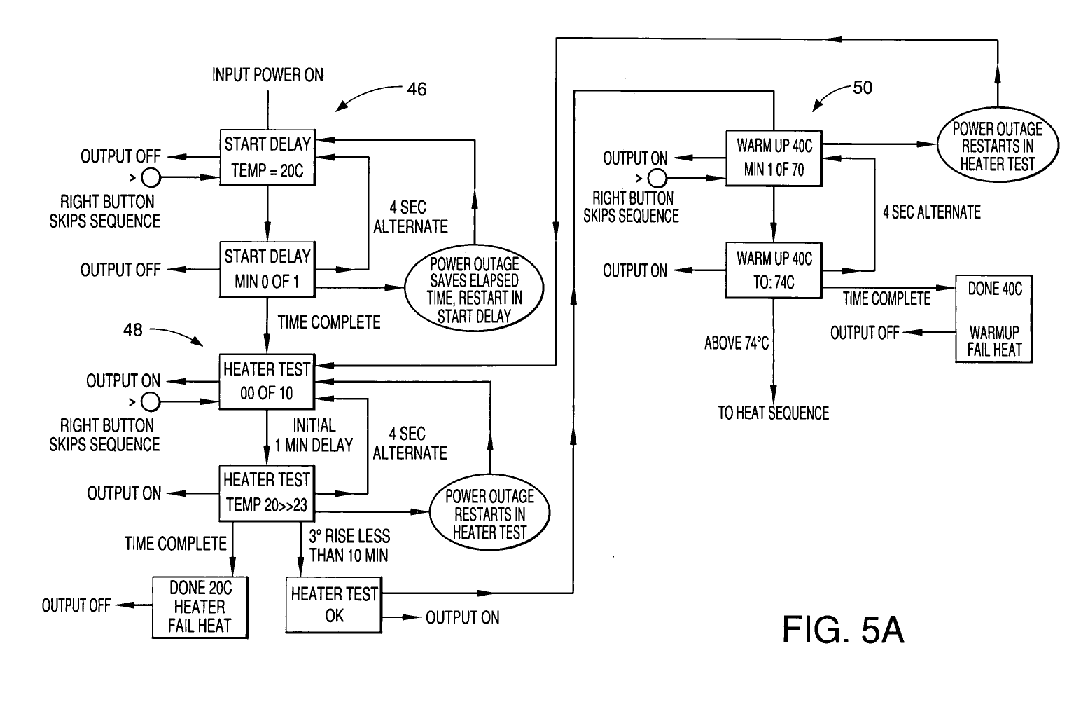

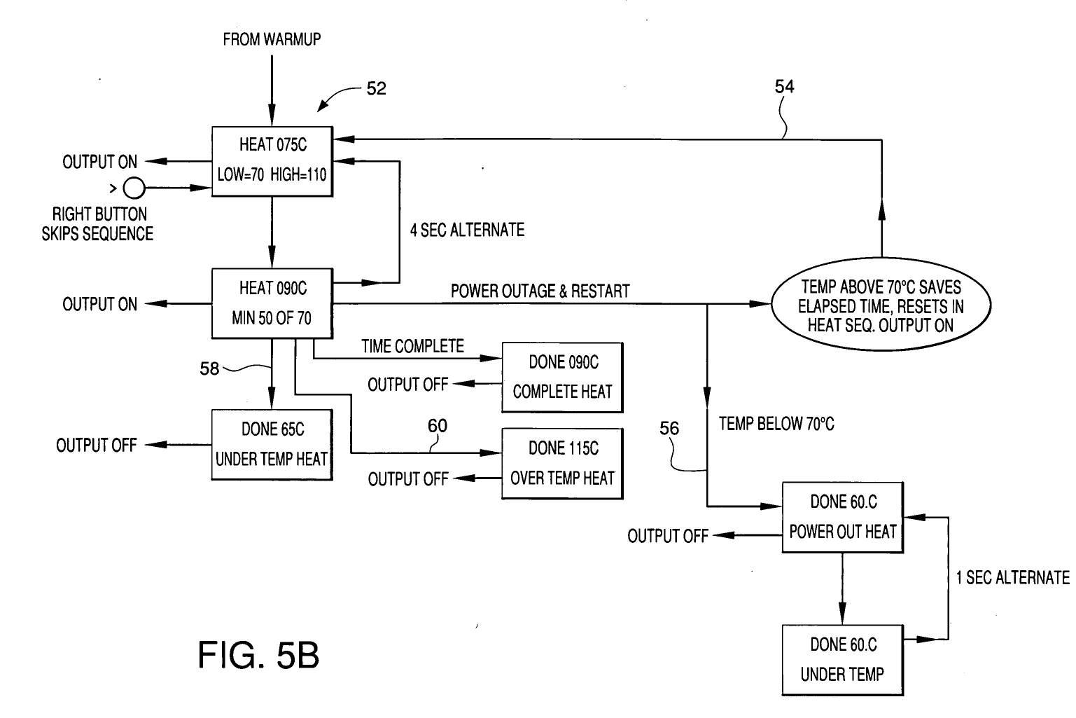

FIGS. 5A and 5B depict the operational flow and display sequence of a temperature controller backup device according to the present invention when set according to the operational parameters input by a user pursuant to FIG. 3. When the power switch 16 is turned to “on” (and the mode switch 20 is switched to run after reset is initiated and the adjust parameters are satisfactory to the user) no power is supplied to the main temperature controller and the microprocessor board 24 initiates a “Start Delay” sequence 46. At a predetermined time interval, e.g., 4 seconds, the display screen alternates between displays of the “Start Delay” sequence temperature and time. At any time during the “Start Delay” sequence a user may press the right arrow button to selectively override the sequence, whereby the remainder of the sequence is skipped and the device proceeds to a “Heater Test” sequence 48. Assuming the right arrow button is not pressed, the “Start Delay” sequence runs to its selected time of completion and device 10 thereafter proceeds to the “Heater Test” sequence. If, however, a power outage occurs during the “Start Delay” sequence, timer means controlled and preferably carried by microprocessor board 16 saves the “Start Delay” time elapsed until the power outage occurred. When power is restored, the microprocessor board restarts the “Start Delay” sequence at the previously elapsed time and the sequence proceeds to completion.

Following completion of the “Start Delay” sequence, the microprocessor board initiates “Heater Test” sequence 48. In “Heater Test”, power is supplied from the backup temperature controller device 10 to the main temperature controller 36. After an optional delay, e.g., one minute, the display screen alternates between displays of the “Heater Test” sequence progress time and temperature at a predetermined time interval, e.g., 4 seconds. At any time during the “Heater Test” sequence a user may press the right arrow button to skip the remainder of the sequence and proceed to a “Warm Up” sequence 50. Assuming the right arrow button is not pressed, the “Heater Test” sequence runs a test procedure which measures temperature increase in the medium 41 as a function of time. If the test is successful, power continues to be supplied from the backup temperature controller device 10 to the main temperature controller 36 and the “Warm Up” sequence begins. If the test is unsuccessful, power from the backup temperature controller device 10 to the main temperature controller 36 is terminated. By way of example but not limitation, a heater test may be based on a rise in temperature of 3° C. in 10 minutes. Preferably, although not necessarily, the optional delay and heater tests are preprogrammed immutable operations performed by microprocessor board 16 which are suitable for the intended application of device 10. It will be appreciated that, with respect to cooling apparatus, device 10 is capable of performing a “Cooler Test” sequence which runs a test procedure that measures temperature decrease in a medium as a function of time.

In the event of a power outage during the “Heater Test” sequence, the microprocessor board 16 restarts the “Heater Test” sequence at its beginning when power is restored. The “Heater Test” sequence is useful in detecting more than a malfunctioning heater 38. It is also beneficial in determining whether sensor probe 40 is properly connected to the sensor input jack 30 or is properly disposed in medium 41. Under any of these circumstances, the temperature sensed by sensor probe 40 will not rise, thereby alerting the user to check both the heater and sensor probe for problems. Moreover, if the user is not present during the heater test and the test fails, microprocessor board cuts power to output power relay 32. And, display screen 24 shows the user “Done 20C Heater Fail Heat.”

Following successful completion of the “Heater Test” sequence, the microprocessor board initiates the “Warm Up” sequence. In “Warm Up”, power continues to be supplied from the backup temperature controller device 10 to the main temperature controller 36. At a predetermined time interval, e.g., 4 seconds, the display screen alternates between displays of the “Warm Up” sequence time and temperature. Assuming the right arrow button is not pressed, the “Warm Up” sequence runs a warm up procedure which measures temperature increase in the medium 41 as a function of time. If the procedure is successful, power continues to be supplied from the backup temperature controller device 10 to the main temperature controller 36 and the “Heat” sequence begins. If the procedure is unsuccessful, power from the backup temperature controller device 10 to the main temperature controller 36 is terminated. “Warm Up” sequence time accumulates concurrently with “Heat” time. By way of example but not limitation, a warm up procedure may be based on the “low” limit “Heat” temperature of 70° C. plus a dead band of 4° C. (for a total temperature of 74° C.). The dead band is desirable because it prevents unintended shut off of power to the main temperature controller 36. For example, without a dead band, sensor probe 40 may momentarily detect a temperature slightly below the 70° C. “low” limit “Heat” temperature for the monitored process. Should that occur, power to the main temperature controller would be shut off. A dead band of several degrees avoids this situation, e.g., if the sensor probe momentarily detects a temperature of 73° C. the temperature controller backup device 10 would continue to supply power to the main temperature controller because the detected temperature would still exceed the “low” limit “Heat” temperature by 3° C.

If the “Warm Up” sequence does not reach the “low” limit “Heat” temperature (plus dead band) in the dedicated heat time, the procedure is considered a failure and power to the main temperature controller is shut off. If the “Warm Up” sequence does reach the “low” limit “Heat” temperature (plus dead band) in the dedicated heat time, the procedure is considered a success, power continues to be supplied to the main temperature controller 36 and backup temperature controller device 10 proceeds to the “Heat” sequence 52 shown in FIG. 5B. It will be appreciated that, with respect to cooling apparatus, device 10 is capable of performing a “Cool Down” sequence which determines whether a medium has cooled sufficiently in a desired period of time.

Assume a power outage occurs during the “Warm Up” sequence. When power is restored, the microprocessor board restarts the “Heater Test” sequence to confirm heater function. This return to the “Heater Test” sequence adds an extra measure of control in the event of a power outage since the process under scrutiny has not yet reached the desired process temperature band. Since the system returns to “Heater Test” following a power outage in “Warm Up”, accumulated heat time is lost and the “Warm Up” sequence must start anew, assuming a successful “Heater Test” sequence.

Turning to FIG. 5B, the device 10 initiates the “Heat” sequence 52 following a successful “Warm Up” sequence. In “Heat”, power is supplied from the backup temperature controller device 10 to the main temperature controller 36. At a predetermined time interval, e.g., 4 seconds, the display screen alternates between displays of the “Heat” sequence temperature information (including real-time sensed temperature and “high” and “low” acceptable process temperature limits) and accumulated time. At any time during the “Heat” sequence a user may press the right arrow button to skip the remainder of the sequence. If a power outage occurs during the “Heat” sequence, the aforementioned timer means saves the accumulated “Warm Up” and “Heat” time elapsed until the power outage occurred. When power is restored, the temperature detected by sensor 40 is checked to determine whether the monitored process is still within its acceptable temperature band. If it is, the “Heat” sequence is restarted at the previously elapsed time and proceeds to completion of the sequence (see flow diagram branch 54). If it is not, e.g., the process temperature has fallen to 60° C. and therefore below the “low” temperature limit for the process temperature band, power to the main temperature controller 36 is shut off and the process is terminated (see flow diagram branch 56). A significant advantage of this restart functionality is that it permits restart of the monitored process. In presently available backup temperature controller devices, the system simply shuts off and remains shut off following a power outage until it is manually restarted, regardless of the duration of the power outage. If a user is not available to restart the temperature monitoring equipment following a brief power outage of an otherwise acceptable “in-band” process, then the process material might have to be discarded and the entire process must be rerun.

Assuming there is no power outage, the process may be terminated if the process falls below the “low” limit or exceeds the “high” limit of the acceptable process temperature band (see flow diagram branches 58 and 60, respectively). If the process temperature remains within-band, the process continues to expiration of the selected heat time at which power to the main temperature controller 36 is shut off. It will be appreciated that, with respect to cooling apparatus, device 10 is capable of performing a “Cool” sequence analogous to the “Heat” sequence described herein.

While an exemplary implementation of the present invention is disclosed for use in connection with a main temperature controller in a laboratory environment, the invention is not so limited. Indeed, it is contemplated for use in connection with any residential, commercial, research or industrial appliances or equipment where temperature plays a significant role. For example, many aspects and features of the invention may be incorporated into residential/commercial appliances such as ovens, coffee brewing machines, toasters, ovens, freezers, refrigerators and so forth, as well as industrial/research equipment such as kilns, furnaces, cryogenic freezers and so forth.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. A backup device for a heating or cooling apparatus temperature controller, the backup device being capable of a plurality of modes of operation and comprising:
a temperature sensor;
sensor input means for receiving temperature data sensed by said temperature sensor;
a microprocessor board operable to automatically control a heating or cooling apparatus temperature controller responsive to timing data and to temperature data received by said sensor input means;
a power supply and power switch;
a mode switch for enabling selection among said plurality of modes of operation;
display means including a circuit board and a display screen; and
an output power relay operable to supply or terminate power flow to a heating or cooling apparatus temperature controller responsive to commands received from said microprocessor board.

2. The backup device of claim 1 wherein said plurality of modes of operation comprise an adjust mode wherein a user interacts with prompts displayed by said display screen to establish heating or cooling process control parameters.

3. The backup device of claim 2 wherein said plurality of modes of operation further comprise a reset mode wherein a user views said display screen and reviews heating or cooling process control parameters input during said adjust mode.

4. The backup device of claim 2 wherein said plurality of modes of operation further comprise a run mode wherein the backup device controls operation of a heating or cooling apparatus temperature controller pursuant to heating or cooling process control parameters input during said adjust mode.

5. The backup device of claim 2 wherein said heating or cooling process control parameters include a target process temperature, a maximum acceptable process temperature, and a minimum acceptable process temperature.

6. The backup device of claim 2 wherein said heating or cooling process control parameters include a start delay time for delaying the start of a heating or cooling apparatus temperature controller.

7. The backup device of claim 2 wherein said heating or cooling process control parameters include a finite heating or cooling time for a heating or cooling sequence.

8. The backup device of claim 4 wherein said microprocessor board initiates a plurality of functionally different operational sequences when the backup device is in said run mode.

9. The backup device of claim 8 further comprising means for selectively overriding an operational sequence when the backup device is in said run mode.

10. The backup device of claim 9 wherein said means for selectively overriding comprise input means in communication with said circuit board of said display means.

11. The backup device of claim 9 wherein selectively overriding an operational sequence ends a current operational sequence and proceeds to a subsequent operational sequence.

12. The backup device of claim 4 wherein said microprocessor board initiates a plurality of functionally different operational sequences in said run mode.

13. The backup device of claim 8 wherein said plurality of functionally different operational sequences comprise a start delay sequence wherein said microprocessor board commands said output power relay to supply power to a heating or cooling apparatus temperature controller following a finite period of time selected by a user.

14. The backup device of claim 13 wherein said display screen alternately displays an elapsed start delay time and a start delay temperature during said start delay sequence.

15. The backup device of claim 13 wherein, when a power outage occurs during the start delay sequence, timer means controlled by said microprocessor board saves the start delay time elapsed until the power outage occurred and, when power is restored, said microprocessor board restarts the start delay sequence at the previously elapsed time.

16. The backup device of claim 8 wherein said plurality of functionally different operational sequences comprise a heating or cooling apparatus test sequence wherein the function of a heating or cooling apparatus is determined by sensing a predetermined temperature change in a medium in a predetermined period of time.

17. The backup device of claim 16 wherein said microprocessor board commands said output power relay to supply power to a heating or cooling apparatus temperature controller throughout a successful heating or cooling apparatus test sequence.

18. The backup device of claim 16 wherein said microprocessor board commands said output power relay to terminate power to a heating or cooling apparatus temperature controller in the event of a failed heating or cooling apparatus test sequence.

19. The backup device of claim 16 wherein said display screen alternately displays a heating or cooling apparatus temperature test time and temperature during said heating or cooling apparatus test sequence.

20. The backup device of claim 16 wherein said display screen displays a test sequence failure in the event of a failed heating or cooling apparatus test sequence.

21. The backup device of claim 16 wherein, when a power outage occurs during the heating or cooling apparatus test sequence, said microprocessor board restarts the heating or cooling apparatus test sequence following the power outage.

22. The backup device of claim 8 wherein said plurality of functionally different operational sequences comprise a heating apparatus warm up sequence or cooling apparatus cool down sequence wherein the sensed temperature of a medium must achieve a predetermined temperature in a finite period of time.

23. The backup device of claim 22 wherein said microprocessor board commands said output power relay to supply power to a heating or cooling apparatus temperature controller throughout a heating apparatus warm up sequence or cooling apparatus cool down sequence if the sensed temperature of a medium achieves a predetermined temperature in a finite period of time.

24. The backup device of claim 22 wherein said microprocessor board commands said output power relay to terminate power to a heating or cooling apparatus temperature controller during a heating apparatus warm up sequence or cooling apparatus cool down sequence if the sensed temperature of a medium does not achieve a predetermined temperature in a finite period of time.

25. The backup device of claim 22 wherein said display screen alternately displays a heating apparatus warm up sequence time and temperature or a cooling apparatus cool down sequence time and temperature during said heating apparatus warm up sequence or cooling apparatus cool down sequence.

26. The backup device of claim 22 wherein said display screen displays a heating apparatus warm up sequence failure or a cooling apparatus cool down sequence failure if the sensed temperature of a medium does not achieve a predetermined temperature in a finite period of time.

27. The backup device of claim 22 wherein, when a power outage occurs during a heating apparatus warm up sequence or a cooling apparatus cool down sequence, said microprocessor board starts a heating or cooling apparatus test sequence following the power outage, wherein said heating or cooling apparatus test sequence determines the function of a heating or cooling apparatus by sensing a predetermined temperature change in a medium in a predetermined period of time.

28. The backup device of claim 8 wherein said plurality of functionally different operational sequences comprise a heating apparatus heat sequence or cooling apparatus cool sequence wherein a medium is heated or cooled for a finite period of time within a predetermined temperature band.

29. The backup device of claim 28 wherein said microprocessor board commands said output power relay to supply power to a heating or cooling apparatus temperature controller throughout a heating apparatus heat sequence or cooling apparatus cool sequence if the sensed temperature of a medium remains within said predetermined temperature band during said finite period of time.

30. The backup device of claim 28 wherein said microprocessor board commands said output power relay to terminate power to a heating or cooling apparatus temperature controller during a heating apparatus heat sequence or cooling apparatus cool sequence if the sensed temperature of a medium falls without said predetermined temperature band during said finite period of time.

31. The backup device of claim 28 wherein said display screen alternately displays a heating apparatus warm up sequence time and temperature or a cooling apparatus cool down sequence time and temperature during said heating apparatus heat sequence or cooling apparatus cool sequence.

32. The backup device of claim 28 wherein said display screen displays successful completion of a heating apparatus heat sequence or a cooling apparatus cool sequence if the sensed temperature of a medium remains within said predetermined temperature band during said finite period of time.

33. The backup device of claim 28 wherein said display screen displays unsuccessful completion of a heating apparatus heat sequence or a cooling apparatus cool sequence if the sensed temperature of a medium falls without said predetermined temperature band during said finite period of time.

34. The backup device of claim 28 wherein, when a power outage occurs during a heating apparatus heat sequence or a cooling apparatus cool sequence, timer means controlled by said microprocessor board saves the heating apparatus heat sequence or the cooling apparatus cool sequence time elapsed until the power outage occurred and, when power is restored, said microprocessor board restarts the heating apparatus heat sequence or cooling apparatus cool sequence at the previously elapsed time if the heating apparatus heat sequence or the cooling apparatus cool sequence remained within said predetermined temperature band during the power outage.

35. The backup device of claim 28 wherein said microprocessor board commands said output power relay to terminate power to a heating or cooling apparatus temperature controller if the heating apparatus heat sequence or the cooling apparatus cool sequence fell without said predetermined temperature band during the power outage.

36. The backup device of claim 1 wherein the backup device and cooling apparatus temperature controller are contained within different housings.

37. The backup device of claim 1 wherein the backup device and cooling apparatus temperature controller are contained within the same housing.

38. A backup device for a heating or cooling apparatus temperature controller, the backup device being capable of a plurality of modes of operation and comprising:
a temperature sensor;
sensor input means for receiving temperature data sensed by said temperature sensor;
a microprocessor board operable to automatically control a heating or cooling apparatus temperature controller responsive to timing data and to temperature data received by said sensor input means;
a power supply and power switch;
a mode switch for enabling selection among said plurality of modes of operation;
display means including a circuit board and a display screen; and
an output power relay operable to supply or terminate power flow to a heating or cooling apparatus temperature controller responsive to commands received from said microprocessor board,
wherein said microprocessor board initiates at least one of a plurality of functionally different operational sequences when the backup device is in a run mode of operation in which the backup device controls operation of a heating or cooling apparatus temperature controller pursuant to heating or cooling process control parameters established by a user, said functionally different operational sequences being selected from the group consisting essentially of:
a start delay sequence wherein said microprocessor board commands said output power relay to supply power to a heating or cooling apparatus temperature controller following a finite period of time selected by a user;
a heating or cooling apparatus test sequence wherein the function of a heating or cooling apparatus is determined by sensing a predetermined temperature change in a medium in a predetermined period of time;
a heating apparatus warm up sequence or cooling apparatus cool down sequence wherein the sensed temperature of a medium must achieve a predetermined temperature in a finite period of time; and
a heating apparatus heat sequence or cooling apparatus cool sequence wherein a medium is heated or cooled for a finite period of time within a predetermined temperature band.

39. The backup device of claim 38 further comprising means for selectively overriding an operational sequence when the backup device is in said run mode.

40. The backup device of claim 39 wherein said means for selectively overriding comprise input means in communication with said circuit board of said display means.

41. The backup device of claim 39 wherein selectively overriding an operational sequence ends a current operational sequence and proceeds to a subsequent operational sequence.
